(19) United States
(12) Patent Application Publication
(10) Pub. No.: US 2009/0243973 A1
(43) Pub. Date: Oct. 1, 2009

(54) DISPLAY DEVICE

(76) Inventors: Masato Ishii, Tokyo (JP); Naruhiko Kasai, Yokohama (JP); Tohru Kohno, Kokubunji (JP); Hajime Akimoto, Kokubunji (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/416,249

(22) Filed: Apr. 1, 2009

(30) Foreign Application Priority Data
Apr. 1, 2008 (JP) 2008-095011

(51) Int. Cl. G09G 3/20

(52) U.S. Cl. 345/55

(57) ABSTRACT

Provided is a display device including: a display section including a plurality of pixels which emit light in an amount varied depending on an amount of current; signal lines used to input a display signal voltage to the pixels; a switch circuit which switches between the signal lines to output signals corresponding to pixel states of the pixels, the pixel states being obtained through a supply of a power source to the pixels; and an A/D converter which sequentially detects the signals corresponding to the pixel states of the pixels along a horizontal line of the display section, in which the A/D converter includes a circuit for changing a reference voltage of the A/D converter, and is structured so as to perform block-by-block detection of signals corresponding to pixel states of pixels in each of a plurality of blocks into which the pixels in the horizontal line are divided.

### CROSS-REFERENCE TO RELATED APPLICATION

The present application claims priority from Japanese application JP 2008-095011 filed on Apr. 1, 2008, the content of which is hereby incorporated by reference into this application.

### BACKGROUND OF THE INVENTION

1. Field of the Invention

The present invention relates to a display device, for example, a display device that includes self-luminous elements as its display elements.

2. Description of the Related Art

The propagation of various computers has produced various devices designed to their specific roles. Among those display devices, so-called self-luminous devices whose display elements are self-luminous elements are attracting attention. Known display devices of this type use as their display elements organic electro luminescence (EL) elements or organic light emitting diodes, for example. Self-luminous display devices do not need a backlight, which makes them suitable for low-power consumption uses, and have such advantages over conventional liquid crystal displays as higher pixel visibility and quicker response speed. Further, these light emitting elements have characteristics similar to those of diodes, which means that the luminance can be controlled via the amount of current let flow in the light emitting element. Self-luminous display devices are disclosed in, for example, JP 2006-91709 A.

In a display device structured as this, the characteristics of the light emitting elements thereof are such that the internal resistance value of the light emitting elements inevitably varies depending on the length of use and the surrounding environment. Particularly, the nature of light emitting elements dictates that the internal resistance of a light emitting element that is in use for long rises with time, thus decreasing the amount of current flowing into the light emitting element. Accordingly, in cases where pixels in the same one place within the display's screen are kept lit, for example, when displaying a menu, the burn-in phenomenon takes place in that place. Correcting this state requires detecting the pixel state. The pixel state is detected in a retrace period of displaying operation. In a retrace period, light is not emitted and no voltage is applied to pixels. An other power source separate from one used for light emission is therefore employed to apply a certain level of constant current to pixels in a retrace period, and voltage detection is made in this state, whereby degradations related to burn-in are detected from a change in voltage. A known example of the correction method that involves pixel state detection is described in JP2006-91860A. In this example, monitoring elements are placed side by side in the row direction of light emitting elements of a display section, a base current source supplies a constant current to the monitoring elements, and voltages generated in the monitoring elements as a result are applied to a plurality of light emitting elements placed by the monitoring elements in the row direction, whereby the light emitting elements are driven on constant voltage.

However, the display device described in JP 2006-91860 A can detect the state of pixels in the display section only in the row direction along which the monitoring elements are provided, and does not take into account fluctuation characteristics in the column direction. It is therefore desirable to detect the pixel state in each pixel separately but, in that case, an increase in scale of a circuit for detecting the pixel state is unavoidable. This has led to a demand for a way to compensate for the display performance of deteriorated pixels, which is accompanied by an in-plane gradient and fluctuations of the display section, without increasing the scale of the detection circuit.

### SUMMARY OF THE INVENTION

It is therefore an object of the present invention to provide a display device capable of compensating for the display performance of deteriorated pixels, which is accompanied by an in-plane gradient and fluctuations of the display section, without increasing the scale of a detection circuit.

Ideally, a reference detection value is set at the start (for example, at the left end of the display section) and is not changed until one round of detection covering one frame or one line is completed. In practice, however, external causes make detected values vary significantly. A display device according to the present invention avoids this by setting finely partitioned detection areas. The detection voltage, which is varied by the influence of an in-plane gradient, is kept inside a variation range that can be handled within the detection range of a detector (A/D converter), and hence the scale of the detection circuit is not increased. To keep the detection voltage variation range inside the detection range of the A/D converter, detection is made by setting a small detection pixel count per reference voltage, in other words, by dividing detection pixels into small blocks.

According to an aspect of the present invention, a display device includes: a display section including a plurality of pixels which emit light in an amount varied depending on an amount of current; signal lines used to input a display signal voltage to the plurality of pixels; a switch circuit which switches between the signal lines to output signals corresponding to pixel states of the plurality of pixels, the pixel states being obtained through a supply of a power source to the plurality of pixels; and an A/D converter which sequentially detects the signals corresponding to the pixel states of the plurality of pixels along a horizontal line of the display section, in which the A/D converter includes a circuit for changing a reference voltage of the A/D converter, and is structured so as to perform block-by-block detection of signals corresponding to pixel states of pixels in each of a plurality of blocks into which the plurality of pixels in the horizontal line are divided.

According to the display device of the present invention, the display performance of the deteriorated pixels, which is accompanied by the in-plane gradient and the fluctuations of the display section, can be compensated without increasing the scale of the detection circuit (A/D converter).

Other effects of the present invention become clear by reading the description herein in its entirety.

### BRIEF DESCRIPTION OF THE DRAWINGS

In the accompanying drawings:

FIG. 1 is a schematic structural diagram of a display according to the present invention;

FIG. 2 is a structural diagram illustrating a pixel detection section of the display according to the present invention;

FIG. 3 is a structural diagram illustrating an A/D conversion section in the pixel detection section;

FIG. 4 is a structural diagram illustrating an A/D circuit in the A/D conversion section;

FIG. 5 is a diagram illustrating line detection that is made in an ideal situation in the course of pixel detection;

FIG. 6 is a diagram illustrating line detection that is made in an actual environment in the course of the pixel detection;

FIG. 7 is a diagram illustrating changes on a line basis in the line detection of a panel's display section;

FIG. 8 is a diagram illustrating a range structure of the A/D circuit;

FIGS. 9A and 9B are explanatory diagrams illustrating block-by-block pixel detection according to the present invention;

FIG. 10 is a diagram illustrating a relation between detection of a block and pixels within the block;

FIG. 11 is a diagram illustrating display and detection timing according to a first embodiment of the present invention;

FIG. 12 is a diagram illustrating how pixels are detected in a perpendicular direction of the display section according to the first embodiment;

FIG. 13 is a flow chart concerning overall control according to the first embodiment;

FIG. 14 is a flow chart concerning detection control according to the first embodiment;

FIG. 15 is a diagram illustrating display and detection timing according to a second embodiment of the present invention;

FIG. 16 is a flow chart concerning detection control according to the second embodiment;

FIG. 17 is a diagram illustrating an example of detection pixel count within a block according to a third embodiment of the present invention;

FIG. 18 is a flow chart concerning detection control according to the third embodiment;

FIG. 19 is a diagram illustrating how pixels are detected in the perpendicular direction of the display section according to a fourth embodiment of the present invention;

FIG. 20 is a diagram illustrating how pixels are detected in the perpendicular direction of the display section according to a fifth embodiment of the present invention; and

FIG. 21 is a diagram illustrating how pixels are detected in the perpendicular direction of the display section according to a sixth embodiment of the present invention.

### DETAILED DESCRIPTION OF THE INVENTION

Embodiments of the present invention are described below with reference to the drawings. Throughout the drawings and the embodiments, identical or similar components are denoted by the same reference symbols in order to omit repetitive descriptions.

### First Embodiment

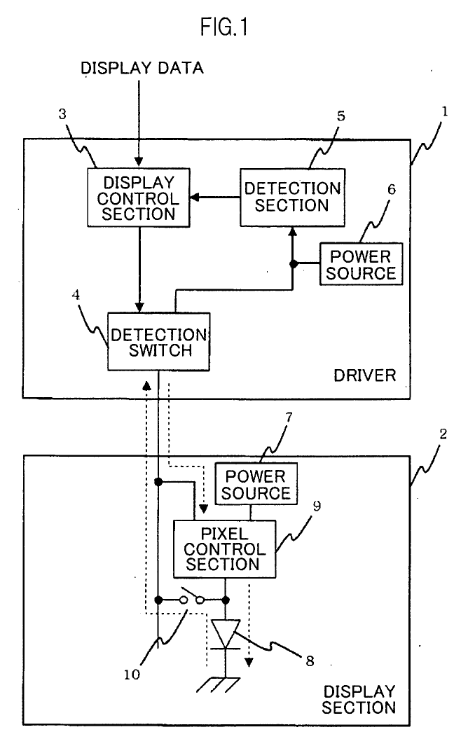

FIG. 1 is a schematic structural diagram of a display device according to the present invention. The display device includes a driver 1 and a display section 2. The driver 1 includes a display control section 3, a detection switch 4, a detection section 5, and a detection-use power source 6. The display section 2 includes a display-use power source 7, a display element 8, a pixel control section 9, and a switch 10. Display data received from the outside is input to the display control section 3 of the driver 1. The display control section 3 performs timing control of the display data and signal control. There are roughly three different signal flows inside the driver 1, which are a display route, a detection route, and a correction route. On the display route, the display data enters the display section 2 via the display control section 3 and the detection switch 4, and then drives the display element 8 with the display-use power source 7 via the pixel control section 9. The detection route runs from the display element 8 to the detection section 5 via the switch 10 and the detection switch 4. The correction route runs from the detection section 5 to the display control section 3, and in the correction route, the display data is corrected. The detection switch 4 switches between a data direction for displaying and a data direction for detection. In a displaying operation, the display-use power source 7 is used as the power source of the display section 2 and, in a detection operation, the detection-use power source 6 is used as the power source of the display section 2. The power source count, which is two in this embodiment, is increased or decreased depending on the display structure, and the power source type, too, is varied between a current source and a voltage source depending on cases. The pixel control section 9 uses the display data to control the display-use power source 7 in the display operation and, in the detection operation, uses the detection-use power source 6 to transmit state data of the display element 8 to the detection section 5.

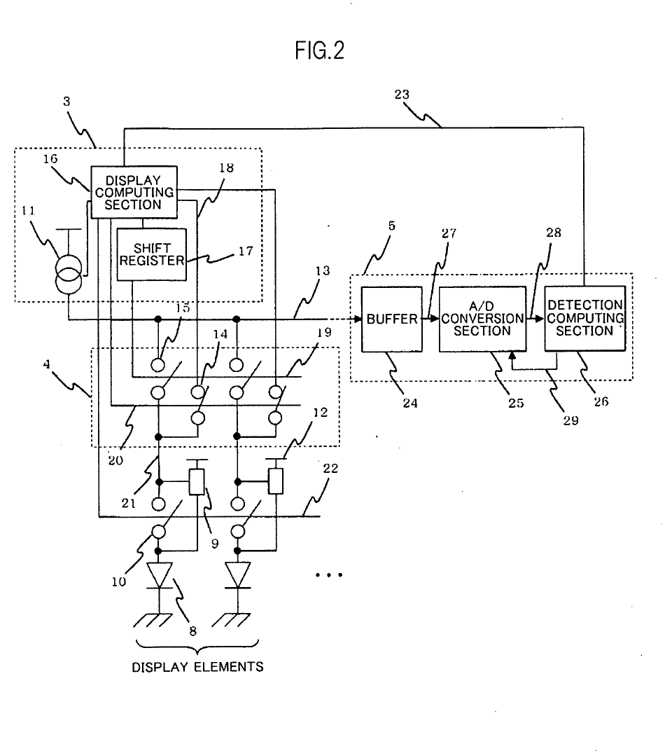

FIG. 2 is a diagram illustrating the structural diagram of FIG. 1 in more detail. The display of FIG. 2 has an organic EL element as an example of the display element (denoted by Reference Symbol 8 in the drawings). The display element 8 is driven on separate power sources in the detection operation and in the displaying operation. In the detection operation, a detection-use current source 11 is used as the detection-use power source 6 and, in the displaying operation, a display-use voltage source 12 is used as the display-use power source 7. The display-use voltage source 12 is preferably shared by display elements that contribute to the displaying operation. A switch 14 is connected to a display computing section 16 by a signal line 18, and is turned on in the displaying operation. The detection-use current source 11 is connected to a switch 15 by a detection line 13. The switch 14 and the switch 15 are never turned on concurrently. The display computing section 16 controls the switches and the power sources, and performs detection and correction. A shift register 17 may be incorporated in the display computing section 16 or may be disposed as an independent control section, and is controlled by the display computing section 16. A signal line 21 is a shared line which is used in the displaying operation and the detection operation both. The switch 14 connected to the signal line 21 is controlled with a control signal 20, which is controlled by the display computing section 16, whereas the switch 15 is controlled with a control signal 19, which is controlled by the shift register 17. The display-use voltage source 12 and the display element 8 are connected to each other by the pixel control section 9. The detection-use current source 11 and the display-use voltage source 12 are separate power sources, but may be integrated into the current source or the voltage source depending on the detection structure. The signal line 21 and the display element 8 are connected to each other by the switch 10. The switch 10 is controlled with a mode selection signal 22, which is controlled by the display computing section 16. A result of detecting the pixel state is obtained in the detection section 5 via the detection line 13. The detection section 5 includes a buffer 24, an A/D conversion section 25, and a detection computing section 26. The buffer 24 amplifies the value of the detection line 13 and outputs the amplified value to a signal 27. The A/D conversion section 25 converts the analog value of the signal 27 into the digital value of a signal 28. The detection computing section 26 calculates a correction amount from the digital value of the signal 28, and outputs the correction amount to the display computing section 16 via a signal 23. The A/D conversion section 25 is controlled with a control signal 29, which is sent from the detection computing section 26. The detection computing section 26 may contain a setting register and a setting memory, and hence the detection method and various settings can be changed through those components' setting values.

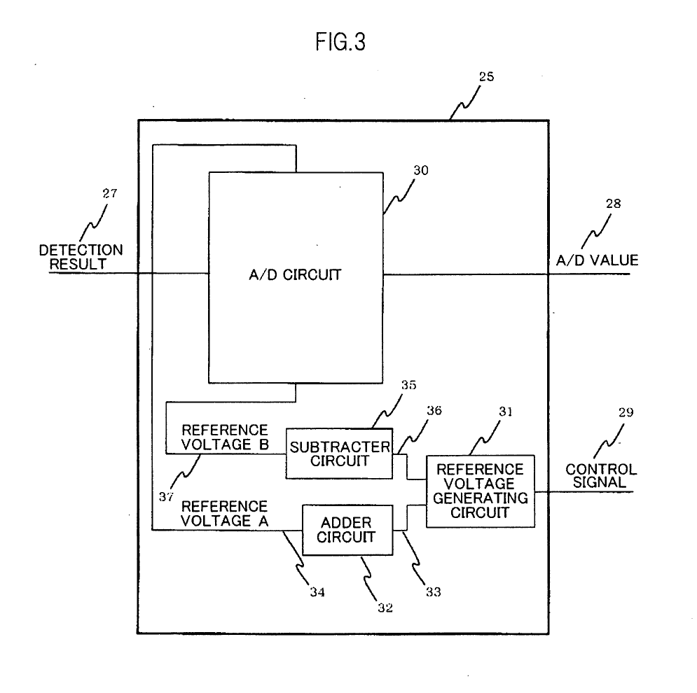

FIG. 3 is an internal structural diagram illustrating an example of the A/D conversion section 25. As illustrated in FIG. 3, the signal 27 which indicates a detection result is input to the A/D conversion section 25, and the signal 28 which has undergone an A/D conversion in an A/D circuit 30 is taken out of the A/D conversion section 25 as an output. The A/D conversion section 25 has a reference voltage generating circuit 31, an adder circuit 32, and a subtracter circuit 35. The A/D conversion section 25 takes in the control signal 29 from the detection computing section 26 illustrated in FIG. 2, the control signal 29 is input to the reference voltage generating circuit 31, and the reference voltage generating circuit 31 outputs a signal 33 and a signal 36. The signal 33 and the signal 36 may have the same value or different values. The signal 33 is input to the adder circuit 32, and the adder circuit 32 outputs a reference voltage A, which is supplied to the A/D circuit 30. The signal 36 is input to the subtracter circuit 35, and the subtracter circuit 35 outputs a reference voltage B, which is supplied to the A/D circuit 30. The reference voltage A denoted by 34 and the reference voltage B denoted by 37 are used as reference voltages of the A/D circuit 30.

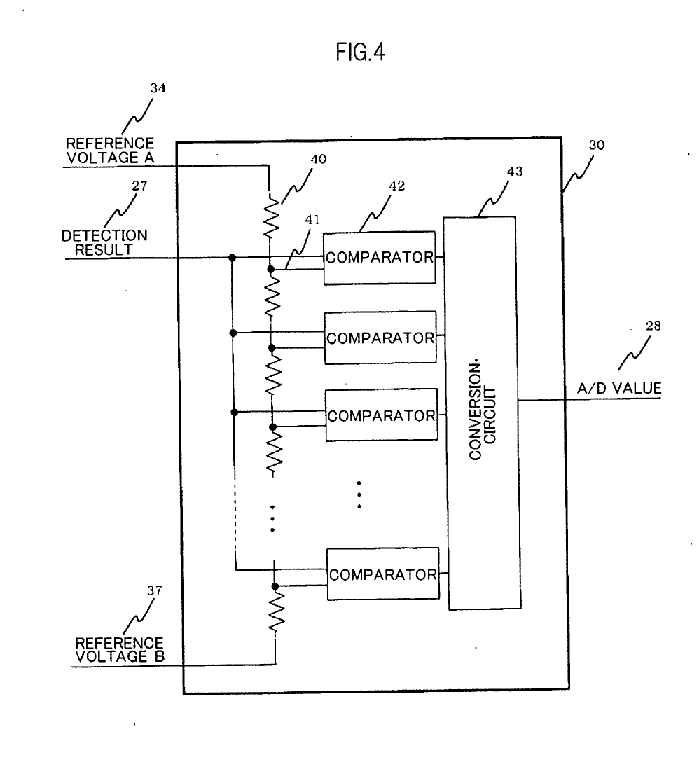

FIG. 4 is a diagram illustrating the internal structure of an example of the A/D circuit 30. In FIG. 4, the A/D circuit 30 uses a comparator 42 to compare a reference value 41, which is generated from the reference voltage A 34 and the reference voltage B 37, with a detection result indicated by the input signal 27. One of the reference voltage A 34 and the reference voltage B 37 is chosen as a reference line value, which is obtained by adding an offset value to, or subtracting the offset value from, a reference voltage value. The reference value 41 used for the comparison is a value obtained by dividing the voltage between the reference voltage A 34 and the reference voltage B 37 by resistor ladders 40. The comparator 42 compares the detection result 27 against the thus calculated reference value 41. While the example of FIG. 4 has seven comparators 42, the count of the comparators 42 and the count of the resistor ladders 40 can be increased or decreased according to the desired comparison accuracy.

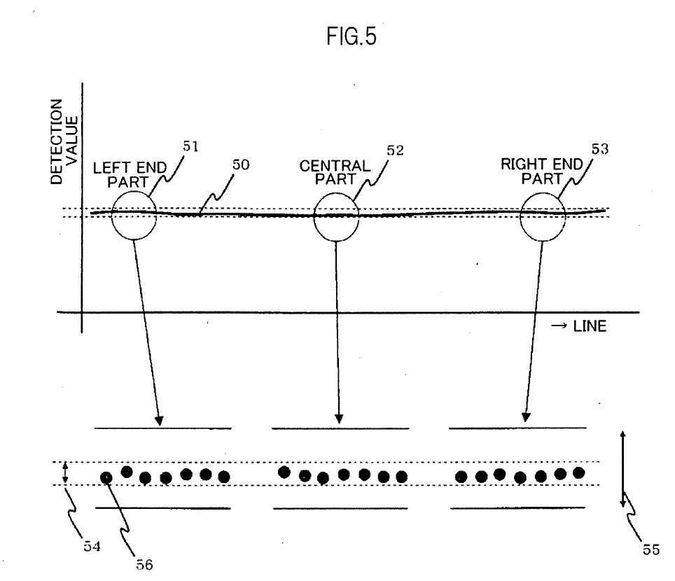

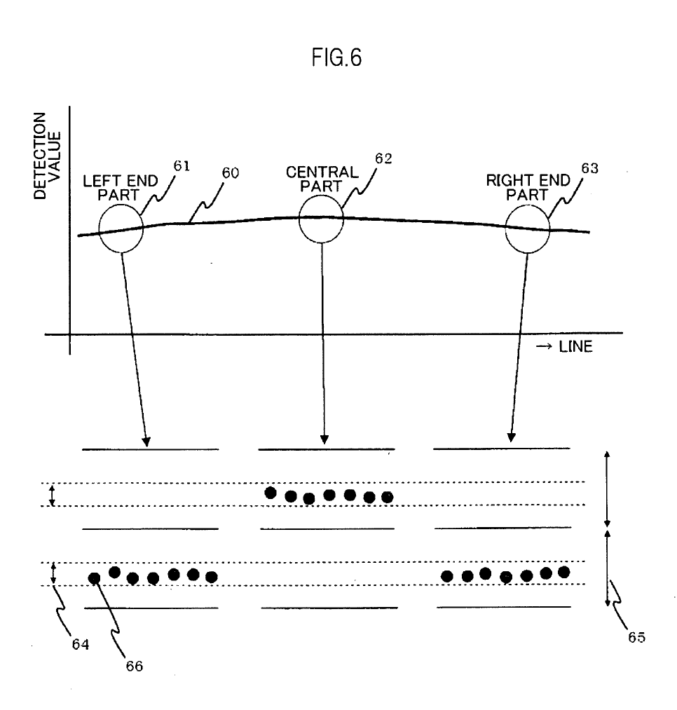

FIG. 5 illustrates a result of detection performed on one horizontal line in a display area of the display (panel) in a situation where there are no external causes. In FIG. 5, the axis of abscissa illustrates points along the one horizontal line and the axis of ordinate represents detection values. FIG. 5 takes into account only fluctuations unique to the display panel, for example, fluctuations of thin film transistor (TFT) switches for pixel selection. As illustrated in FIG. 5, a result 50 of one line of detection exhibits no fluctuations and no burn-ins, and shows that successful detection is made generally with a constant value. Detection points along the one line are a left end part 51, a central part 52, and a right end part 53. Enlarged views of detection results at the respective points are illustrated in the lower part of FIG. 5. It is understood from the enlarged views that, at each pixel, the detection result (for example, one denoted by Reference Symbol 56 in FIG. 5) fluctuates within a range 54. A range 55 of FIG. 5 represents the minimum range of detection by the A/D circuit 30. When there are no fluctuations, the detection value 56 always takes the same value and accordingly the range 54 is not observed. In contrast to FIG. 5, FIG. 6 illustrates a result of detection performed on one horizontal line in the display area in a situation that contains external causes. FIG. 6 is similar to FIG. 5 in that detection is performed on one horizontal line in the display area, and differs from FIG. 5 in that the influence of ambient temperature and the like are taken into account in addition to fluctuations that are unique to the display panel. A result 60 of detection of one line is not constant throughout the one line due to the influence of external causes. Detection points along the one line are a left end part 61, a central part 62, and a right end part 63. A range 64 indicates the range of fluctuations unique to the display panel, and therefore has substantially the same values as the range 54 illustrated in FIG. 5. A range 65 represents the minimum range of A/D detection. In this example, the detection voltage at the central part 62 greatly differs from the one at the left end part 61 or the right end part 63, with the result that the A/D detection range has two stages. The present invention proposes a detection method that takes into account such influence of external causes.

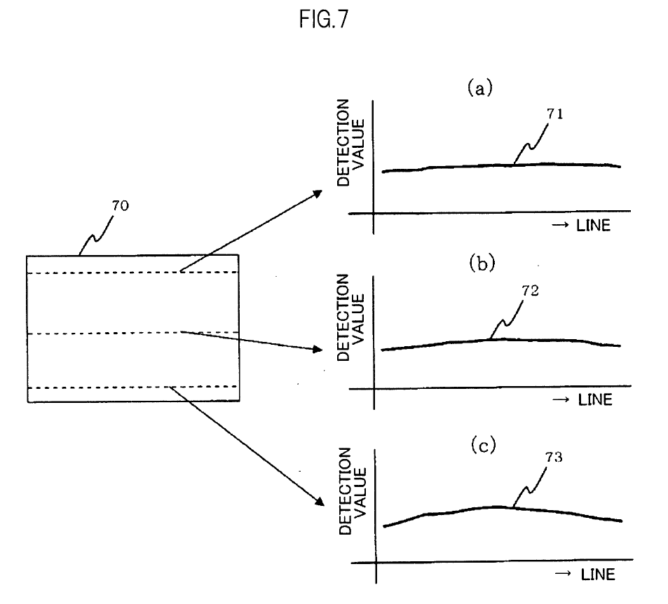

FIG. 7 illustrates the above-mentioned horizontal direction detection in a display area 70 of the panel. A detection result in an upper part of the display area 70 is illustrated as a detection value 71 in (a). A detection result in a middle part of the display area 70 is illustrated as a detection value 72 in (b). A detection result in a lower part of the display area 70 is illustrated as a detection value 73 in (c). This example illustrates characteristics in which fluctuations are small in the upper part of the display area and become progressively larger toward the lower part of the display area 70. Fluctuation characteristics, which vary from one panel to another, are not limited to those illustrated in FIG. 7 and could form other various patterns.

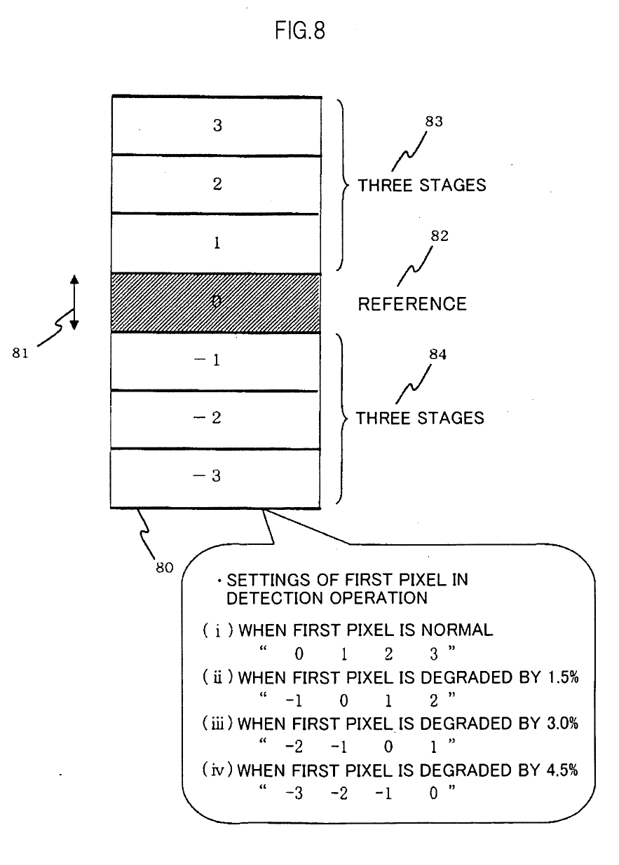

FIG. 8 is a diagram illustrating the range structure of the A/D circuit 30. The minimum range in a range 80 of the A/D circuit 30 is a range 81 illustrated in FIG. 8. Within this range, a three-stage voltage range 83 is set on the plus side of a reference voltage 82 and a three-stage voltage range 84 is set on the minus side of the reference voltage 82. The count of the stages corresponds to the total count of the comparators 42 (seven, in this embodiment) and, in this embodiment, also corresponds to the count of corrections made as becomes clear from a description below. In the case of performing three-stage detection, for example, on the premise that the detection result always falls in one of four stages in a certain range, settings are varied depending on the first detection result. For instance, when the first pixel operates normally and the detection result at the first pixel falls in “0”, the range to be used is composed of “0”, “1”, “2”, and “3”. When the first pixel is degraded by, for example, 1.5% and the detection result at the first pixel falls in “−1”, the range to be used is composed of “−1”, “0”, “1”, and “2”. When the first pixel is degraded by, for example, 3.0% and the detection result at the first pixel falls in “−2”, the range to be used is composed of “−2”, “−1”, “0”, and “1”. When the first pixel is degraded by, for example, 4.5% and the detection result at the first pixel falls in “−3”, the range to be used is composed of “−3”, “−2”, “−1”, and “0”. No problem arises when all detection results of one line of detection fall within this range. However, there is a considerable possibility that external causes push some of the detection results outside of the range.

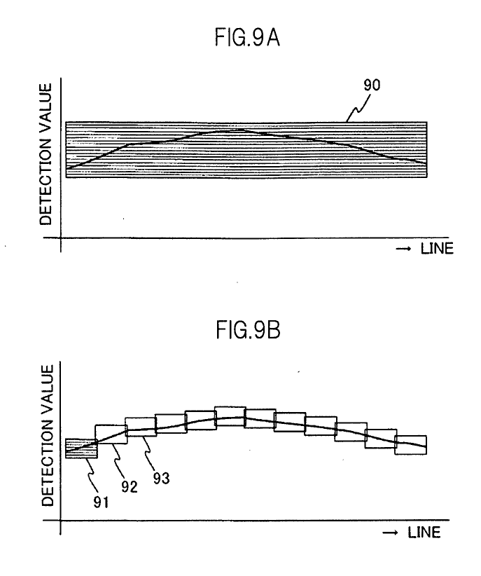

FIG. 9A illustrates one of methods of obtaining all detection values along one horizontal line of the display area when the detection values vary greatly (the case of (c) of FIG. 7). FIG. 9A indicates that, with a block 90 set so as to contain all of the detection values, a single A/D circuit 30 is required to have a range that covers the block 90. The count of the comparators 42 of the A/D circuit 30 in this case is equal to or higher than a count obtained by dividing a necessary range w by the minimum range of the A/D circuit 30. For example, when the detection range and minimum range of the A/D circuit 30 are 1 V and 20 mV, respectively, fifty stages are necessary, which makes the circuit scale of the A/D circuit 30 large.

In contrast to FIG. 9A, FIG. 9B illustrates a method of obtaining detection values according to the present invention. As illustrated in FIG. 9B, a block 91, a block 92, a block 93 . . . , each of which is a significantly smaller area than the block 90 are set in a manner that follows changes in detection value, and hence a detection result is obtained for each of the blocks 91, 92, 93 . . . separately. This way, even when the count of the comparators 42 of the A/D circuit 30 is as small as, for example, seven, detection results can be obtained by moving the block in the horizontal direction as many times as the division count in a manner that does not exceed the detection range.

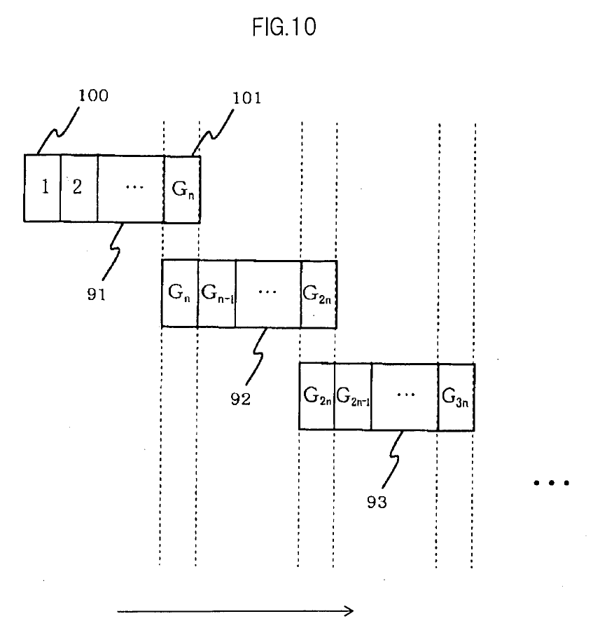

FIG. 10 illustrates detection that is performed on each of pixels aligned next to each other along a horizontal line in each of the above-mentioned blocks. In FIG. 10, the arrow indicates the direction of the horizontal line, and, for the convenience of description, the blocks 91, 92, 93 . . . are sequentially shifted in a direction perpendicular to this horizontal line direction. The pixel detection count is constant in all blocks in this embodiment and is denoted by Gn. In the block 91, the first pixel to the Gn-th pixel are sequentially detected to obtain, for example, a detection result 100 from the first pixel and a detection result 101 from the Gn-th pixel. Those detection results may be separate absolute values, or may be relative values obtained by calculating the differences between the detection results of adjacent pixels. In the latter case, pixels from the Gn-th pixel, which is the last pixel of the preceding block 91, to the G2n-th (G2n=Gn+pixel detection count) pixel are detected in the second block 92. Similarly, in the third block 93, pixels from the G2n-th pixel, which is the last pixel of the preceding block 92, to the G3n-th (G3n=G2n+pixel detection count) pixel are detected. Making the last pixel of one block and the first pixel of the next block common in this way has an effect of securing a reliable continuity between blocks when detection results are obtained as a relative value in the manner described above.

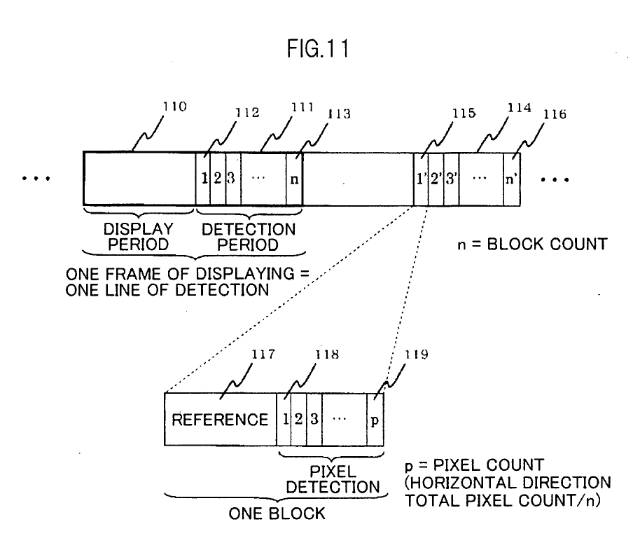

FIG. 11 is a diagram illustrating display and detection timing. In this embodiment, for example, one line of detection is performed when one frame of data is displayed. As illustrated in an upper part of FIG. 11, one frame of displaying is constituted of a display period and a retrace period, which are repeated. This embodiment allocates the retrace period as a detection period, and hence one frame is constituted of a display period 110 and a detection period 111. The detection period 111 is divided into n blocks, n being the block count of one line. In the upper part of FIG. 11, a block 112 is the first block and a block 113 is the n-th block. A detection period 114 of the next frame is similarly divided into n blocks. The first block and n′-th block of the detection period 114 are a block 115 and a block 116, respectively. A lower part of FIG. 11 illustrates details of each block in the detection period 114. In the lower part of FIG. 11, a reference generation period and a pixel detection period are set in one block, and a pixel 118 is the first pixel and a pixel 119 is the p-th pixel. The pixel count p per block is a count obtained by dividing the total pixel count of one horizontal line by the block count n.

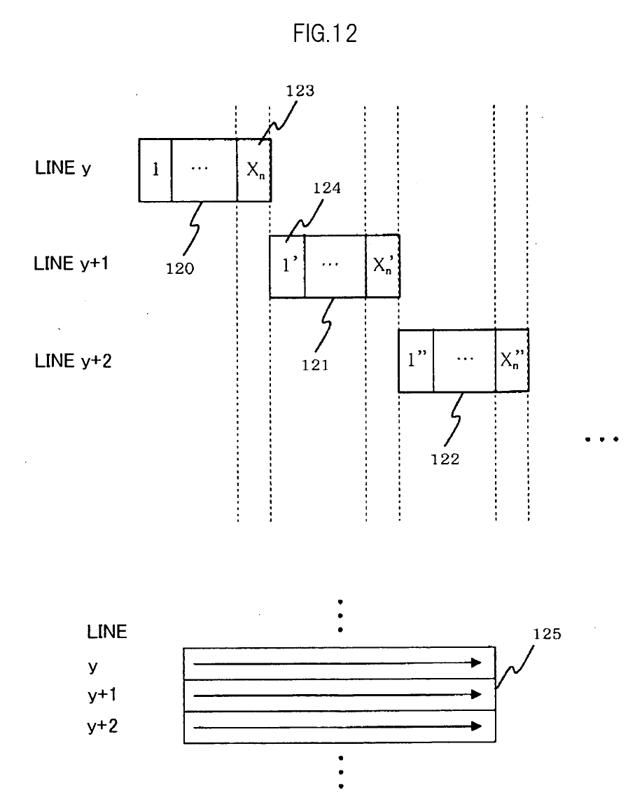

FIG. 12 is a diagram illustrating an example of how horizontal lines are detected sequentially in the perpendicular direction. As illustrated in an upper part of FIG. 12, the total pixel count along a single horizontal line is Xn. A detection result in a line (horizontal line) y is obtained as a result 120, a detection result in the next line, namely, a line y+1, is obtained as a result 121, and a detection result in the line next to the line y+1, namely, a line y+2, is obtained as a result 122. In this example, a detection value 123 of the last pixel in the line y differs from a detection value 124 of the first pixel in the next line y+1. This is because, as illustrated in a lower part of FIG. 12, detection is made for each horizontal line separately without allowing adjacent lines, for example, the line y and the line y+1, to have a common detection value in an overlapping manner.

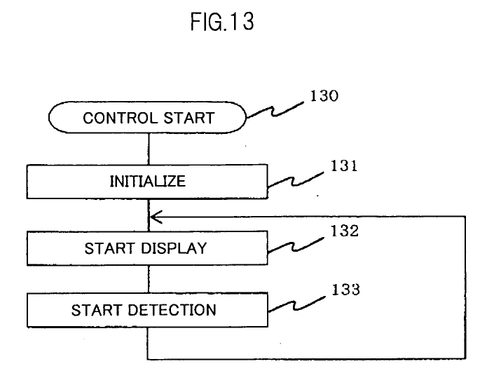

FIG. 13 is a control flow chart for displaying an image with pixels. In FIG. 13, processing of the displaying operation is started in a processing step 130, and the system is initialized in a processing step 131. Subsequently, display processing is started in a processing step 132 and detection processing is started in a processing step 133. The processing step 132 and the processing step 133 are repeated while the system is in operation. The start of the displaying operation in the processing step 132 and the start of the detection operation in the processing step 133 are executed within one frame of displaying as described above.

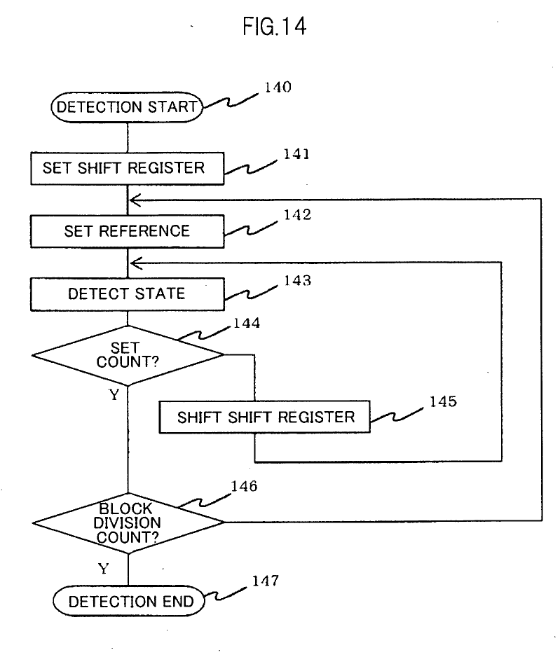

FIG. 14 is a control flow chart for pixel detection, and illustrates details of the processing step 133 of FIG. 13. In FIG. 14, detection control is started in a processing step 140, and initializing settings are set to the shift register (denoted by Reference Symbol 17 in FIG. 2) in a processing step 141. Thereafter, a reference voltage is set in a processing step 142 and the pixel state is detected in a processing step 143. Whether or not a set pixel count of the block has been reached is determined in a processing step 144. When the set pixel count has not been reached, the shift register is shifted in a processing step 145, and the processing step 143 and subsequent steps are repeated. When the set pixel count of the block is reached in the processing step 144, whether or not the block count has reached a set count is determined in a processing step 146. When the set block count has not been reached, the processing step 142 and subsequent steps are repeated. When the set block count is reached in the processing step 146, the detection operation is ended in a processing step 147.

### Second Embodiment

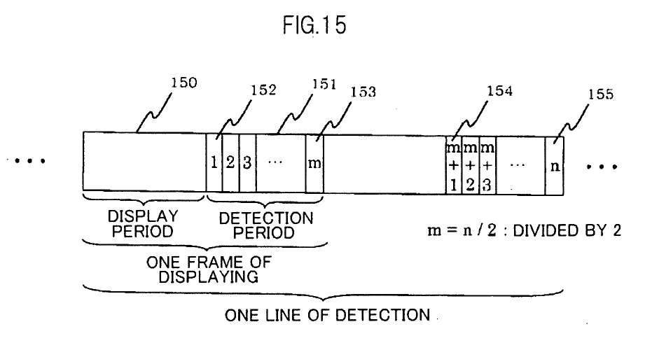

FIG. 15 is a diagram of a display according to a second embodiment of the present invention, and corresponds to FIG. 11 of the first embodiment. In the structure illustrated in FIG. 15, detection is performed on one horizontal line for two frames of displaying. A single frame is constituted of a display period and a retrace period, and the retrace period is allocated as a detection period (denoted by Reference Symbol 151 in FIG. 15) as described above.

The detection period 151 is divided into m blocks, m being half the block count n of one horizontal line. In short, m in this example is n/2. The detection period 151 is set as this in order to deal with a case where one horizontal line of detection cannot be completed within the detection period of one frame, and pixels in the remaining blocks are detected in the next frame. If the detection takes longer than that, the division count can be increased, in which case the count of display frames required for one horizontal line of detection increases. In FIG. 15, the detection period 151 in the first frame has a block 152 as the first block and a block 153 as the m-th block. The detection period of the next frame has a block 154 as the (m+1)-th block and a block 155 as the n-th block. Pixels are detected in order from the first block to the n-th block, whereby the detection of pixels along one horizontal line is finished.

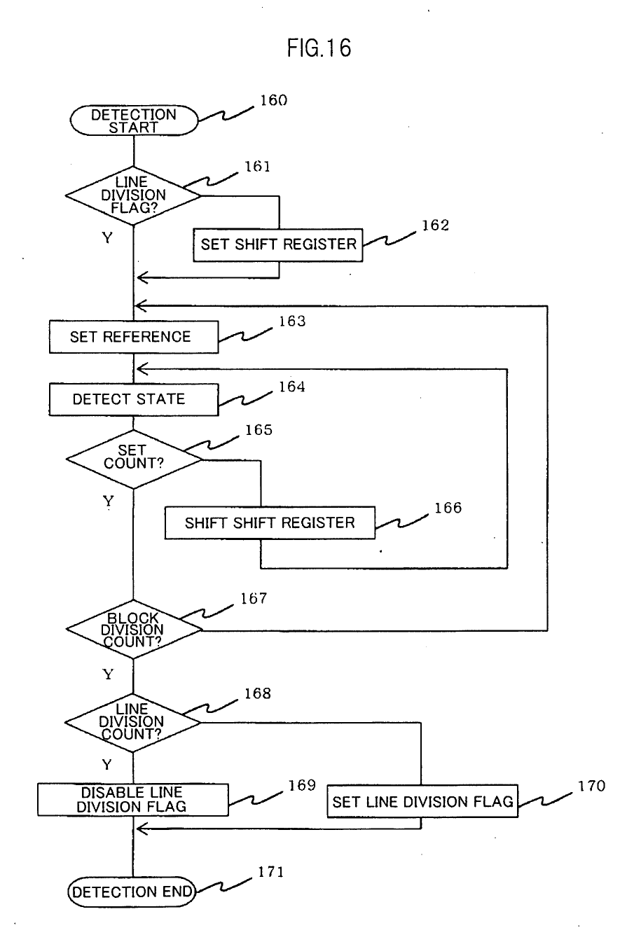

FIG. 16 is a control flow chart for the pixel detection illustrated in FIG. 15. Detection control is started in a processing step 160, and whether or not a line division flag is on is checked in a processing step 161. The line division flag indicates whether the processing of detecting one horizontal line of pixels in a plurality of frames is in progress or finished. When the line division flag is on, it means that the detection processing is underway and, when the line division flag is off, it means that the detection processing has been finished. In the case where the line division flag is off in the processing step 161, in other words, when detection is performed on the line for the first time, initializing settings are set to the shift register (denoted by Reference Symbol 17 in FIG. 2) in a processing step 162. After the processing step 162, or when the line division flag is on in the processing step 161, a reference voltage is set in a processing step 163 and the pixel state is detected in a processing step 164. Whether or not the set pixel count of the block has been reached is determined in a processing step 165. When a set pixel count has not been reached, the shift register is shifted in a processing step 166, and the processing step 164 and subsequent steps are repeated. When the set pixel count of the block is reached in the processing step 165, whether or not the block count has reached a set count is determined in a processing step 167. When the set block count has not been reached, the processing step 163 and subsequent steps are repeated. When the set block count is reached in the processing step 167, and the line division count reaches a set count in a processing step 168, the line division flag is changed to “off” in a processing step 169. When the set line division count has not been reached in the processing step 168, the line division flag is changed to “on” in a processing step 170. The detection operation is then ended in a processing step 171.

### Third Embodiment

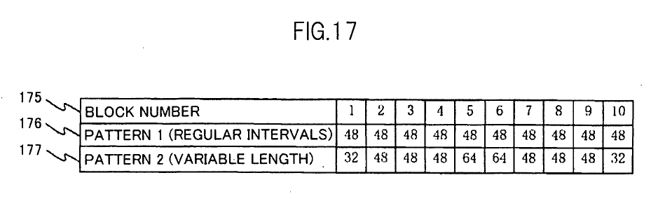

FIG. 17 is a diagram of a display according to a third embodiment of the present invention, and is relevant to the description of FIG. 17 of the first embodiment. In this structure, pixels in each horizontal line are detected by keeping the block division count constant and varying the detection pixel count from one block to another. As illustrated in FIG. 17, a block number 175 indicates numbers assigned to blocks into which one line is divided. For example, one line is divided into ten blocks. A pattern 1 (regular intervals) 176 indicates that pixels are detected at regular intervals for each block. The descriptions of the first embodiment and the second embodiment are given on the premise that the pattern 1 is employed. This embodiment, on the other hand, employs a pattern 2 in which, as indicated by a pattern 2 (variable length) 177, the detection pixel count is set smaller at the head of one horizontal line, larger in the middle, and smaller again at the tail of the horizontal line. This is because increasing the detection pixel count at the central part of the display area when the fluctuation characteristics of detection values are as illustrated in (c) of FIG. 7 makes reliable correction of pixel characteristics possible. There are many other combinations, and one suited to the panel's characteristics is set.

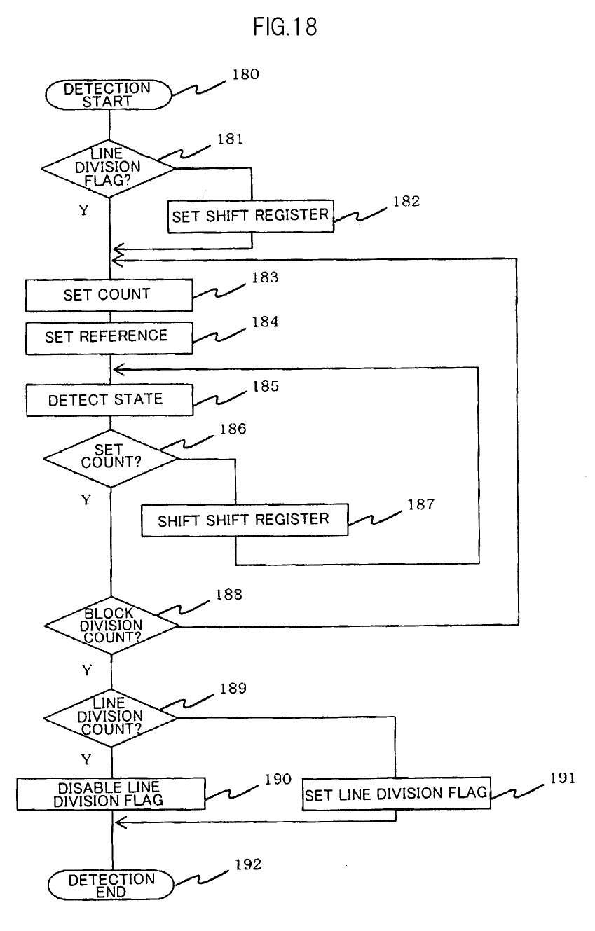

FIG. 18 is a control flow chart for the pixel detection illustrated in FIG. 17. As illustrated in FIG. 18, detection control is started in a processing step 180, and whether or not the line division flag is on is checked in a processing step 181. The line division flag indicates whether the processing of detecting one line of pixels in a plurality of frames is in progress or finished. When the line division flag is on, it means that the detection processing is underway and, when the line division flag is off, it means that the detection processing has been finished. In the case where the line division flag is off in the processing step 181, in other words, when detection is performed on the line for the first time, initializing settings are set to the shift register in a processing step 182. After the processing step 182, or when the line division flag is on in the processing step 181, the detection pixel count is set from the pattern table in a processing step 183, a reference voltage is set in a processing step 184, and the pixel state is detected in a processing step 185. Whether or not the set pixel count of the block has been reached is determined in a processing step 186. When a set pixel count has not been reached, the shift register is shifted in a processing step 187, and the processing step 185 and subsequent steps are repeated. When the set pixel count of the block is reached in the processing step 186, whether or not the block count has reached a set count is determined in a processing step 188. When the set block count has not been reached, the processing step 183 and subsequent steps are repeated. When the set block count is reached in the processing step 188, and the line division count reaches a set count in a processing step 189, the line division flag is changed to “off” in a processing step 190. When the set line division count has not been reached in the processing step 189, the line division flag is changed to “on” in a processing step 191. The detection operation is then ended in a processing step 192.

### Fourth Embodiment

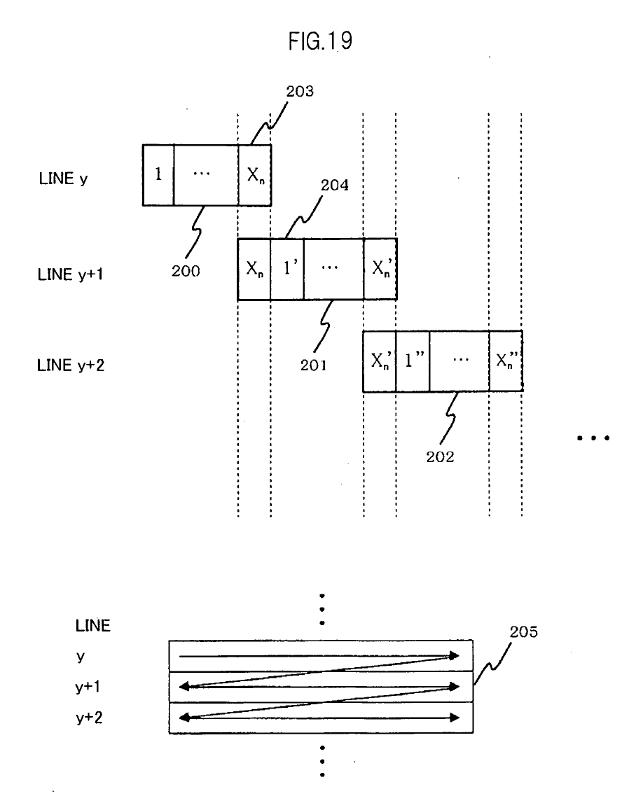

FIG. 19 is a diagram of a display according to a fourth embodiment of the present invention, and corresponds to FIG. 12 of the first embodiment. In this embodiment, as illustrated in an upper part of FIG. 19, the total pixel count in the horizontal line direction is Xn, a detection result in a line y is a result 200, a detection result in the next line, namely, a line y+1, is a result 201, and a detection result in the line next to the line y+1, namely, a line y+2, is a result 202. A last detection value 203 of the result 200 is the same as the first detection value of the result 201, and the first detection value of the line y+1 in the next detection is a detection value 204. As illustrated in a lower part of FIG. 19, in detection of pixels along a horizontal line, the employed detection value is a relative value obtained by calculating the difference between the last detection value of the line y and the first detection value of the line y+1. This is very effective when pixels at the left and right ends of the panel's display area have no fluctuations in detection value.

### Fifth Embodiment

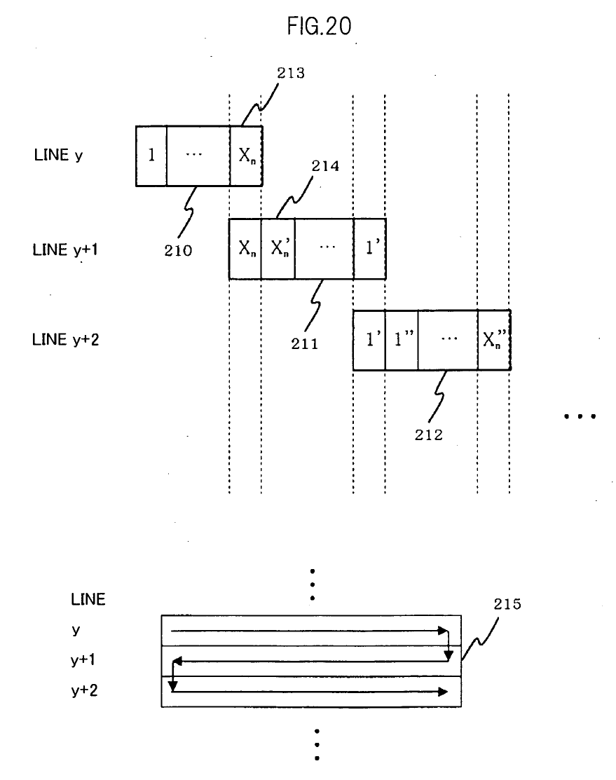

FIG. 20 is a diagram of a display according to a fifth embodiment of the present invention, and corresponds to FIG. 19. This embodiment is characterized in that, as illustrated in a lower part of FIG. 20, the pixel detection direction differs in an odd-numbered horizontal line and in an even-numbered horizontal line. Specifically, pixels are detected sequentially along a path that runs in a zigzag fashion over the display area. As illustrated in an upper part of FIG. 20, a detection result in a line y is a result 210, a detection result in the next line, namely, a line y+1, is a result 211, and a detection result in the line next to the line y+1, namely, a line y+2, is a result 212. A last detection value 213 of the result 210 is the same as the first detection value of the result 211, and the last detection value of the line y+1 in the next detection is a detection value 214. The detection direction in the result 211 of the line y+1 is reverse to that in other lines as described above, but continuous relative values can be obtained as detection values.

### Sixth Embodiment

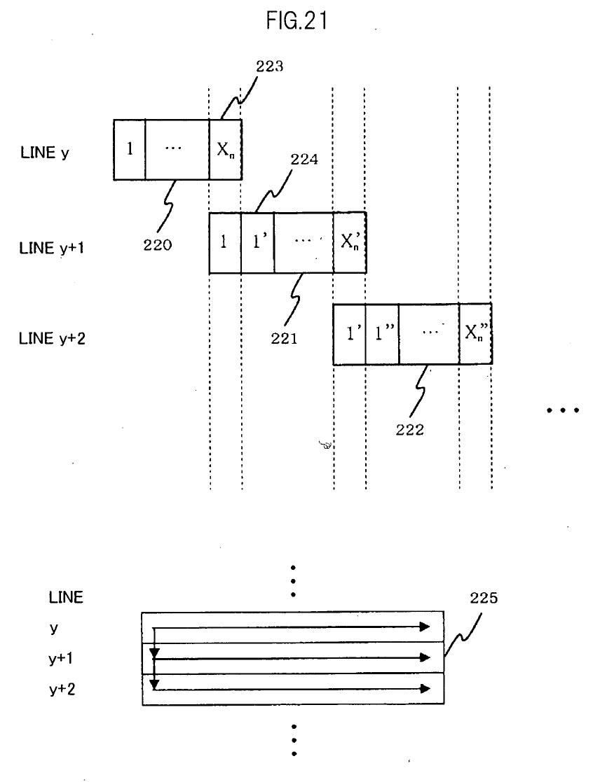

FIG. 21 is a diagram of a display according to a sixth embodiment of the present invention, and corresponds to FIG. 12. As illustrated in a lower part of FIG. 21, pixels are detected in the same direction in all horizontal lines. As illustrated in an upper part of FIG. 21, the total pixel count of each horizontal line is Xn. A detection result in a line y is a result 220, a detection result in the next line, namely, a line y+1, is a result 221, and a detection result in the line next to the line y+1, namely, a line y+2, is a result 222. A first detection value 223 of the result 221 is the same as the detection value of the first pixel in the line y, and the detection value of the first pixel in the line y+1 is a detection value 224. The standards of lines can be viewed in a relative light by comparing the value of a pixel at the head of the line y and the value of a pixel at the head of the line y+1. Specifically, detection results can be obtained as relative values by calculating the difference between the first detection value of the line y and the first detection value of the line y+1, and calculating the difference between the first detection value of the line y+1 and the first detection value of the line y+2.

The present invention is applicable as an independent display device, an incorporated display panel, or a display device for a computer terminal.

While there have been described what are at present considered to be certain embodiments of the invention, it is understood that various modifications may be made thereto, and it is intended that the appended claims cover all such modifications as fall within the true spirit and scope of the invention.

What is claimed is:

1. A display device comprising:
a display section including a plurality of pixels which emit light in an amount varied depending on an amount of current;
signal lines used to input a display signal voltage to the plurality of pixels;
a switch circuit which switches between the signal lines to output signals corresponding to pixel states of the plurality of pixels, the pixel states being obtained through a supply of a detection-use power source to the plurality of pixels; and
an A/D converter which sequentially detects the signals corresponding to the pixel states of the plurality of pixels along a horizontal line of the display section,
wherein the A/D converter comprises a circuit for changing a reference voltage of the A/D converter, and is structured so as to perform block-by-block detection of signals corresponding to pixel states of pixels in each of a plurality of blocks into which the plurality of pixels in the horizontal line are divided.

2. A display device according to claim 1,
wherein the A/D converter comprises:
a reference voltage generation circuit;
an adder circuit; and
a subtracter circuit, and
wherein the A/D converter uses the adder circuit to generate a reference voltage around the reference voltage of the A/D converter, and uses the subtracter circuit to generate another reference voltage around the reference voltage of the A/D converter.

3. A display device according to claim 2, wherein the A/D converter comprises a plurality of comparators which generate a plurality of reference states from a pixel state output of a first pixel out of two arbitrary pixels, and which compare the plurality of reference states with a pixel state output of a second pixel out of the two arbitrary pixels.

4. A display device according to claim 1, wherein, from results of block-by-block detection obtained for each of blocks having an arbitrary number of divided pixels in one horizontal line of the display section, the A/D converter reconstructs detection results of the pixels in the one horizontal line.

5. A display device according to claim 4, wherein, in successive blocks, a last detection pixel of a first block and a first detection pixel of a next block are the same pixel.

6. A display device according to claim 4, wherein detection of the pixels in the one horizontal line is executed in each display period of each frame.

7. A display device according to claim 4, wherein detection of the pixels in the one horizontal line is executed over display periods of a plurality of frames.

8. A display device according to claim 4, wherein a detection pixel count in one block differs from a detection pixel count in another block.

9. A display device according to claim 4, wherein, in block-by-block detection of pixels in a plurality of horizontal lines, the same detection direction is employed in all of the plurality of horizontal lines, and a last pixel in one of the plurality of horizontal lines is detected again prior to detection of a first pixel in a next horizontal line to ensure continuity of detection values between the pixels by calculating a difference between the detection values.

10. A display device according to claim 4, wherein, in block-by-block detection of pixels in a plurality of horizontal lines, different detection directions are employed in adjacent horizontal lines, and a last pixel in one of the plurality of horizontal lines is detected again prior to detection of a first pixel in a next horizontal line to ensure continuity of detection values between the pixels by calculating a difference between the detection values.

11. A display device according to claim 4, wherein, in block-by-block detection of pixels in a plurality of horizontal lines, the same detection direction is employed in all of the plurality of horizontal lines, and a first pixel in one of the plurality of horizontal lines is detected again prior to detection of a first pixel in a next horizontal line to ensure continuity of detection values between the pixels by calculating a difference between the detection values.
